(19) United States
(12) Patent Application Publication
(10) Pub. No.: US 2025/0274924 A1
(43) Pub. Date: Aug. 28, 2025

(54) SYSTEMS AND METHODS FOR TIMING FOR SMART NODES

(71) Applicant: ZTE CORPORATION, Shenzhen (CN)

(72) Inventors: Hanqing XU, Shenzhen (CN); Nan ZHANG, Shenzhen (CN); Ziyang Li, Shenzhen (CN); Wei CAO, Shenzhen (CN); Shuang ZHENG, Shenzhen (CN)

(73) Assignee: ZTE CORPORATION, Shenzhen (CN)

(21) Appl. No.: 19/206,105

(22) Filed: May 13, 2025

Related U.S. Application Data
(63) Continuation of application No. PCT/CN2023/108430, filed on Jul. 20, 2023.
Application No. PCT/CN2023/108430 is a continuation-in-part of application No. PCT/CN2023/088645, filed on Apr. 17, 2023.

(51) Int. Cl. H04W 72/0453; H04W 56/00

(52) U.S. Cl. CPC H04W 72/0453; H04W 56/001

(57) ABSTRACT

Presented are systems and methods for timing for smart nodes (SNs). A network node may identify a first timing of a first frequency resource for a first link. The network node may determine a second timing of a second frequency resource for a second link. The first link may comprise at least one of: a first control link from a wireless communication node to the network node; or a second control link from the network node to the wireless communication node. The second link may comprise at least one of: a first forwarding link from the wireless communication node to the network node; a second forwarding link from the network node to the wireless communication node; a third forwarding link from the network node to a wireless communication device; or a fourth forwarding link from the wireless communication device to the network node.

### CROSS-REFERENCE TO RELATED APPLICATION

This application claims the benefit of priority under 35 U.S.C. § 120 as a continuation of International Patent Application No. PCT/CN2023/108430, filed Jul. 20, 2023, which claims priority to International Patent Application No. PCT/CN2023/088645, filed Apr. 17, 2023, the disclosure of each of which is incorporated herein by reference in their entireties.

### TECHNICAL FIELD

The disclosure relates generally to wireless communications, including but not limited to systems and methods for timing for smart nodes (SNs).

### BACKGROUND

Coverage is a fundamental aspect of cellular network deployments. Mobile operators rely on different types of network nodes to offer blanket coverage in their deployments. As a result, new types of network nodes have been considered to increase the flexibility of mobile operators for their network deployments. For example, certain systems or architecture introduce integrated access and backhaul (IAB), which may be enhanced in certain other systems, as a new type of network node not requiring a wired backhaul. Another type of network node is the RF repeater which simply amplify-and-forward any signal that they receive. RF repeaters have seen a wide range of deployments in 2G, 3G and 4G to supplement the coverage provided by regular full-stack cells.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A network node (e.g., a smart node (SN)) may identify a first timing of a first frequency resource for a first link. The network node may determine a second timing of a second frequency resource for a second link. The first link may comprise at least one of: a first control link from a wireless communication node (e.g., a BS) to the network node; or a second control link from the network node to the wireless communication node. The second link may comprise at least one of: a first forwarding link from the wireless communication node to the network node; a second forwarding link from the network node to the wireless communication node; a third forwarding link from the network node to a wireless communication device; or a fourth forwarding link from the wireless communication device to the network node.

In some embodiments, the first frequency resource and/or the second frequency resource refer to at least one of: a carrier, a channel, a passband, a resource block group, a resource block set, a subband, a guard band, a bandwidth part, a frequency band, an operation band, a frequency range, a cell, a serving cell, or a band of frequency spectrum.

In some arrangements, the second timing can be related to the first timing, which refers to at least one of: the second timing of the first forwarding link is aligned with the first timing of the first control link; the second timing of the second forwarding link is aligned with the first timing of the second control link; the second timing of the third forwarding link is delayed after the first timing of the first control link or after the second timing of the first forwarding link by an first time delay; the second timing of the fourth forwarding link is advanced before the first timing of the second control link or before the second timing of the second forwarding link by a an second time delay; or the second timing of the second forwarding link is delayed/advanced after/before the third timing of a third frequency resource of the second control link by an third time delay, wherein the third time delay is related to a difference between the first timing of the first control link and the third timing of a third frequency resource of the first control link.

In some embodiments, the second timing can be related to/aligned with (“aligned with” can be one embodiment of “related to”) the first timing (e.g., the first timing in implementation example 1), when at least one of the following conditions is met: (a) the second frequency resource is any frequency resource within a set of frequency resource for the second link; (b) the second frequency resource is identical to the first frequency resource (e.g., the first carrier in implementation example 1); (c) the first frequency resource and the second frequency resource are in a same frequency band; (d) the second frequency resource is in a frequency resource group or a cell group; (e) the second frequency resource is in a frequency resource declared by the network node; or (f) the second frequency resource is in a frequency resource reported by the network node to the wireless communication node.

In some embodiments, the first carrier (e.g., the first carrier in implementation example 1 or the third carrier in implementation example 2) can be or can not be configured for side control information reception or transmission.

In some embodiments, the second timing can be related to/aligned with (“aligned with” can be one embodiment of “related to”) the first timing (e.g., the third timing in implementation example 2), when at least one of the following conditions is met: (a) the first frequency resource (e.g., the third carrier in implementation example 2) is one frequency resource or any carrier within a set of frequency resource for the second link; (b) the first frequency resource is identical to the second frequency resource; (c) the first frequency resource and the second frequency resource are in a same frequency band; (d) the first frequency resource is in a frequency resource group or a cell group; (e) the first frequency resource is in a frequency resource declared by the network node; or (f) the first frequency resource is in a frequency resource reported by the network node to the wireless communication node.

In some embodiments, the network node may receive a first message indicating at least one or more frequency resource groups, each of which comprising one or more frequency resource. The first frequency resource and the second frequency resource can be in a same one of the one or more frequency resource groups. The one or more frequency resource in a same frequency resource group may share a common timing value. The one or more frequency resource in the same frequency resource group can be supported by the first link. The one or more frequency resource in the same frequency resource group can be within a set of frequency resource for the second link. A timing of one or more frequency resource in the same frequency resource group for the second link can be related to/aligned with a timing of one or more frequency resources in the same frequency resource group for the first link. The common timing value may include a common timing advance offset. The common timing advance offset can be indicated by a second message receiving by the network node from the wireless communication node, or can be determined a default value by the network node.

In some embodiments, the common timing value may include a common timing advance command value in a timing advance command. The timing advance command can be indicated by a third message receiving by the network node from the wireless communication node. The network node may receive a fourth message indicating a reference SCS, or respective SCSs associated with the one or more frequency resources from the wireless communication node. The common timing advance command value can be relative to/related to the reference SCS, or a largest or lowest one of the SCSs, or relative to one of the SCSs associated with a corresponding one of the one or more frequency resources for the first link, or the SCS of the first frequency resource, or the SCS of the second frequency resource. The network node may adjust downlink timing or uplink timing on all the frequency resources in the same frequency resource group based on the common timing value.

In some embodiments, the network node may receive a first message indicating a timing offset from the wireless communication node.

In some arrangements, a unit or a granularity of the timing offset refers to at least one of: N seconds, N milliseconds, N microseconds, N nanoseconds, N frames, N subframes, N slots, N symbols, N·Tc, or M·Tc, wherein N is a positive number, Tc is a time constant, and M is related to a subcarrier spacing configuration. The timing offset may include a first timing offset and/or a second timing offset. The first timing offset may include a propagation delay present between the network node and the wireless communication node, and/or the second timing offset may include a switching delay present between a UL transmission/reception and a DL transmission/reception. The first message may further indicate a third timing offset. The third timing offset can be a combination of the first timing offset and the second timing offset. The network node may receive a second message indicating one or more frequency resources for the second link that correspond to the first timing offset and/or the second timing offset from the wireless communication node.

In some arrangements, the network node may determine the second timing through combining a timing reference and/or the first timing offset and/or the second timing offset, including at least one of the following: the first timing of the first control link is delayed/advanced after/before the timing reference by one or multiple of the first timing offset and/or the second timing offset; the first timing of the second control link is delayed/advanced after/before the timing reference by one or multiple of the first timing offset and/or the second timing offset, or the first timing of the second control link is delayed/advanced after/before the first timing of the first control link by one or multiple of the first timing offset and/or the second timing offset; the second timing of the first forwarding link is delayed/advanced after/before the timing reference by one or multiple of the first timing offset and/or the second timing offset; the second timing of the second forwarding link is delayed/advanced after/before the timing reference by one or multiple of the first timing offset and/or the second timing offset, or the second timing of the second forwarding link is delayed/advanced after/before the second timing of the first forwarding link by one or multiple of the first timing offset and/or the second timing offset; the second timing of the third forwarding link is delayer after the second timing of the first forwarding link by one or multiple of the first timing offset and/or the second timing offset; or the second timing of the fourth forwarding link is advanced before the second timing of the second forwarding link by one or multiple of the first timing offset and/or the second timing offset.

In some embodiments, the timing offset can be a timing difference between the first frequency resource and the second frequency resource, or a timing difference between a current one of the second timing and a new one of the second timing. The first message may further indicate information corresponding to the timing offset. The information may comprise at least one of: the second frequency resource, a frequency band corresponding to the second frequency resource, or an SCS corresponding to the second frequency resource. The timing offset may include a UL timing offset and/or a DL timing offset. The network node may receive a third message indicating a plurality of timing advance offsets from the wireless communication node.

In some embodiments, a first one of the plurality of timing advance offsets can be configured for the first frequency resource. A second one of the plurality of timing advance offsets can be configured for the second frequency resource. The first frequency resource and the second frequency resource may share a common timing advance offset, which can be indicated by a fifth message receiving by the network node from the wireless communication node, or can be determined a default value by the network node.

In some embodiments, the first frequency resource and the second frequency resource may share a common timing advance command value in a timing advance command, which can be indicated by a second message receiving by the network node from the wireless communication node. The common timing advance offset command value can be relative to a reference SCS, a largest or lowest one of a plurality of SCSs associated with the first link and the second link, respectively, or relative to one of the SCSs associated with the first link, or the SCS of the first frequency resource, or the SCS of the second frequency resource.

In some arrangements, the network node may determine the second timing including at least one of the following: the second timing of the first forwarding link is delayed/advanced after/before the first timing of the first control link by one or multiple of the timing offset; the second timing of the second forwarding link is delayed/advanced after/before the first timing of the second control link by one or multiple of the timing offset, or the second timing of the second forwarding link is delayed/advanced after/before the second timing of the first forwarding link by one or multiple of the timing offset; the second timing of the third forwarding link is delayer after the second timing of the first forwarding link by one or multiple of the timing offset; the second timing of the fourth forwarding link is advanced before the second timing of the second forwarding link by one or multiple of the timing offset; or the second timing of the second forwarding link is obtained through at least one of the following parameters: a common timing advance command value, a dedicated timing advance command value, a common timing advance offset, a dedicated timing advance offset, the timing offset.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with some embodiments of the present disclosure;

FIG. 2 illustrates a block diagram of an example base station and a user equipment device, in accordance with some embodiments of the present disclosure;

FIG. 3 illustrates a schematic diagram of transmission links between BS to SN and SN to UE, in accordance with some embodiments of the present disclosure;

FIG. 4 illustrates a graph of two frequency ranges associated with respective links, in accordance with some embodiments of the present disclosure;

FIG. 5 illustrates a framework diagram of an example method for timing for smart nodes (SNs), in accordance with some embodiments of the present disclosure;

FIG. 6 illustrates a graph of two frequency ranges associated with respective links, in accordance with some embodiments of the present disclosure;

FIG. 7 illustrates a graph of two frequency ranges associated with respective links, in accordance with some embodiments of the present disclosure; and

FIG. 8 illustrates a flow diagram of an example method for timing for smart nodes (SNs), in accordance with some embodiments of the present disclosure.

### DETAILED DESCRIPTION

### 1. Mobile Communication Technology and Environment

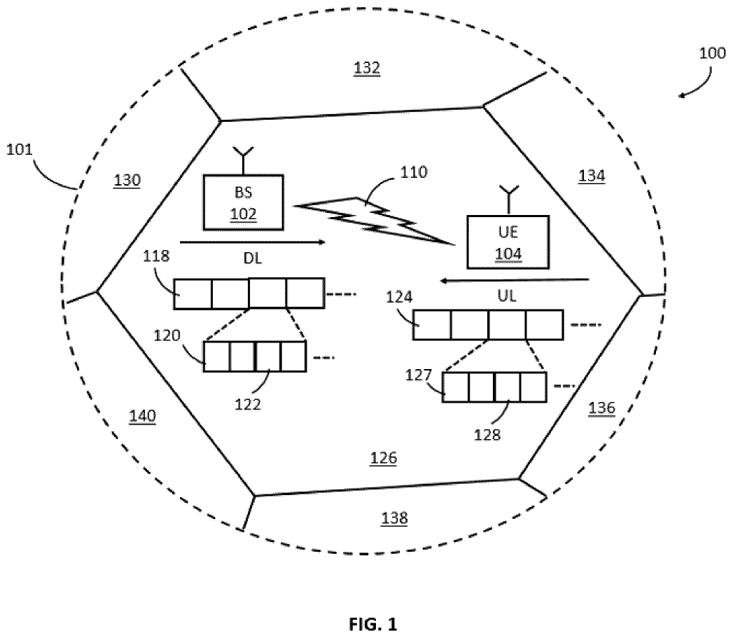

FIG. 1 illustrates an example wireless communication network, and/or system, 100 in which techniques disclosed herein may be implemented, in accordance with some embodiments of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

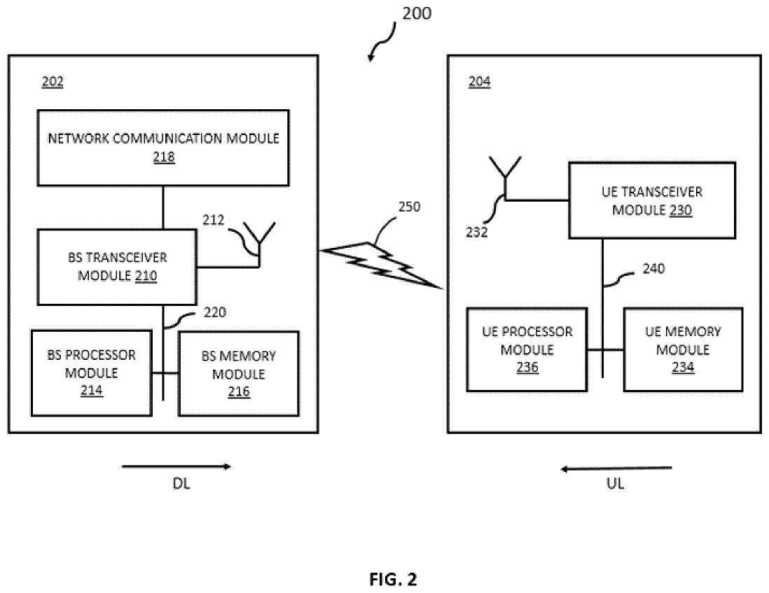

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Timing for Smart Nodes (SNs)

In certain systems (e.g., 5G new radio (NR), Next Generation (NG) systems, 3GPP systems, and/or other systems), a network-controlled repeater (NCR) can be introduced as an enhancement over conventional radio frequency (RF) repeaters with the capability to receive and/or process side control information from the network. As discussed herein, network nodes, including and not limited to network-controlled repeater, smart repeater, Re-configuration intelligent surface (RIS), Integrated Access and Backhaul (IAB), can be denoted as a smart node (SN) (e.g., network node) for simplicity. For example, the SN can include, correspond to, or refer to a kind of network node to assist the BS 102 to improve coverage (e.g., avoiding/averting blockage/obstructions, increasing transmission range, etc.).

In certain cases, a frequency band of a carrier of C-link (e.g., communication/control link or SN CU) may be in a different frequency band from a carrier of F-link (e.g., forwarding link or SN FU). At least not all of the carriers within the set of carriers of F-link may be the same or in the same frequency band as the carrier of C-link. In other words, the two operating frequency bands may be out-of-band. For example, C-link may work in frequency range 1 (FR1) for initial access and to control the forwarding of F-link. F-link may work in frequency range 2 (FR2) for extension of network coverage in FR2 band.

If C-link and F-link are located out-of-band, there may be a Rx/Tx timing difference between C-link and F-link. In some embodiments, a SN FU may include a radio frequency (RF) unit, which by itself cannot detect the signal to obtain timing synchronization. If SN CU controls SN FU forwarding (e.g., to perform on/off, beam management, and/or power control, etc.) based on the timing of C-link, the timing of the C-link can be inaccurate for F-link. Therefore, a mechanism to obtain an accurate timing of F-link in order to accurately control a forwarding of SN FU can be performed.

Coverage can be a fundamental aspect of cellular network deployments. Mobile operators may rely on different types of network nodes to offer blanket coverage in their deployments. Therefore, new types of network nodes have been considered to increase mobile operators' flexibility for their network deployments. For example, Integrated Access and Backhaul (IAB) was introduced as a new type of network node not requiring a wired backhaul. Another type of network node can be the RF repeater which simply amplify-and-forward any signal that it receives. RF repeaters have seen a wide range of deployments in 2G, 3G and 4G to supplement the coverage provided by regular full-stack cells. A RF repeater may have a radio unit.

A network-controlled repeater can be introduced as an enhancement over conventional RF repeaters with the capability to receive and process side control information from the network. Side control information may allow a network-controlled repeater to perform its amplify-and-forward operation in a more efficient manner. Potential benefits includes mitigation of unnecessary noise amplification, transmissions and receptions with better spatial directivity, and simplified network integration. Same mechanism for controlling specified in this disclosure can also be applied to other systems including Re-configuration intelligent surface (RIS).

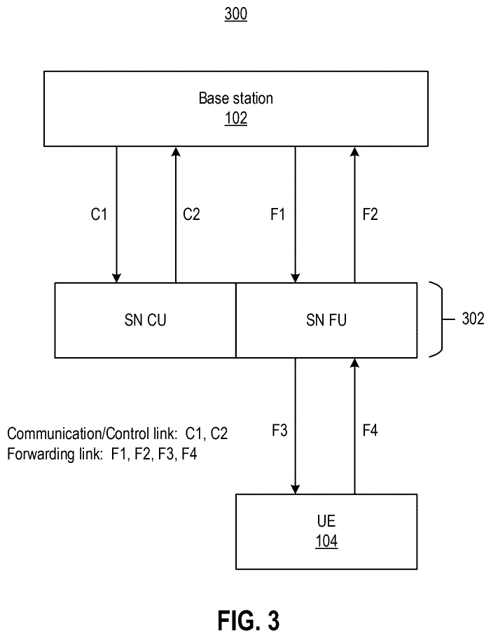

FIG. 3 illustrates a schematic diagram 300 of transmission links between BS 102 to SN 302 and SN 302 to UE 104. The SN 302 can include or consist of at least two functional parts/components/units (e.g., function entities), such as the communication unit (CU) (e.g., SN CU, sometimes referred to as a first function entity or unit)) and the forwarding unit (FU) (e.g., SN FU, sometimes referred to as a second function entity or unit). The function entities can support different functions. For example, the SN CU can be a network-controlled repeater (NCR) MT. In another example, the SN FU can be an NCR forwarder/forwarding (Fwd). The SN CU can act/behave or include features similar to a UE 104, for instance, to receive and decode side control information from the BS 102. The SN CU may be a control unit, controller, mobile terminal (MT), part of a UE, a third-party IoT device, and so on. The SN FU can carry out the intelligent amplify-and-forward operation using the side control information received by the SN CU. The SN FU may be a radio unit (RU), a RIS, and so on. For simplicity, CU (e.g., SN CU) and FU (e.g., SN FU) can correspond to or refer to the first unit and the second unit, respectively.

The transmission links between the BS 102 to SN 302 and the SN 302 to UE 104 as shown in FIG. 3 can be defined/described/provided as follows:
C1: Control link (e.g., C-link or first communication link) from BS to SN CU;
C2: Control link (e.g., C-link or second communication link) from SN CU to BS;
F1: Forwarding link (e.g., F-link or first forwarding link, which in this case can be a backhaul link) from BS to SN FU;
F2: (e.g., F-link or second forwarding link, which in this case can be a backhaul link) from SN FU to BS;
F3: (e.g., F-link or third forwarding link, which in this case can be an access link) from SN FU to UE; and
F4: (e.g., F-link or fourth forwarding link, which in this case can be an access link) from UE to SN FU.

Control link (e.g., sometimes referred to as a communication link) can refer to or mean that the signal from one side will be detected and decoded by the other side, so that the information transmitting in the control link can be utilized to control the status of forwarding links (e.g., backhaul links and/or access links). Forwarding link can mean that the signal from BS 102 or UE 104 is unknown to SN FU. In this case, the SN FU can amplify and forward signals without decoding them. For example, the F2 and F4 links can correspond to or be associated with the complete uplink (UL) forwarding link (e.g., backhaul link and access link, respectively) from UE 104 to BS 102, in which F2 is the SN FU UL forwarding link. Additionally, the F1 and F3 links can correspond to or be associated with the complete DL forwarding link (e.g., backhaul link and access link, respectively) from BS 102 to UE 104, in which F3 is the SN FU DL forwarding link. The F1 and F2 links can correspond to or be referred to as backhaul links (B-link) and F3 and F4 links can correspond to or be referred to as access links (A-link). Backhaul link and access link can be part of forwarding link, and the combination of the two may constitute a complete forwarding link.

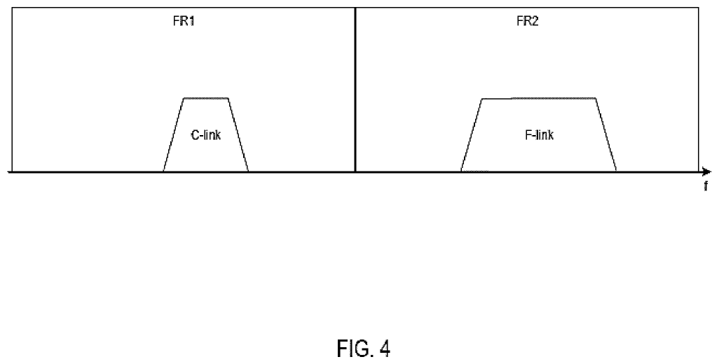

FIG. 4 illustrates a graph of two frequency ranges associated with respective links. For example, the frequency band of the carrier of C-link (e.g., SN CU) may be in a different frequency band from the carrier of F-link (e.g., SN FU), where the two operating frequency bands may be out-of-band. As shown, C-link can work/operate/function in frequency range 1 (FR1) for initial access and/or control the forwarding of F-link. F-link can work in frequency range 2 (FR2) for extension of network coverage.

In this disclosure, carrier can be used as an example of frequency resource to illustrate the timing methods for out-of-band case, which can also correspond to other frequency-related term, e.g. passband, resource block (RB) group, RB set, subband, guard band, BWP, channel, frequency band, frequency resource, frequency range, operating band, cell, serving cell, etc. For example, this disclosure may say “a carrier in a carrier group”, which can be extended to “a subband in a cell group”. The first “carrier” in the sentence can be replaced by “subband” and the second “carrier” is replaced by “cell”.

In present disclosure, the two frequency bands can be out-of-band in at least one of the following cases:
The two frequency bands may correspond to different carriers;
The two carriers may be located in different frequency bands or operating bands;
The two carriers may be in different frequency ranges (e.g. FR1, FR2 (FR2-1, FR2-2)); or
If using other terms e.g. “subband” to replace carrier, out of band may also include the case that: two subband are different subbands.

In the following content, for convenience of description, different frequency bands may represent “out-of-band”. Frequency band can also correspond to carrier, passband, operating band, or frequency range.

If the carriers of C-Link and F-link are out of band, there may be a Rx/Tx timing difference between C-link and F-link. FU may include a RF unit, which by itself cannot detect the signal to obtain timing synchronization. If CU controls FU forwarding based on the timing of C-link, such as to perform ON/OFF, beam management, and/or power control, it may cause resource collision, interference and performance loss as the timing of C-link is inaccurate for F-link. Therefore, the systems and methods discussed herein can provide mechanisms/techniques to obtain the accurate timing of F-link in order to accurately control the forwarding (e.g., forwarding operation/functionality) of FU.

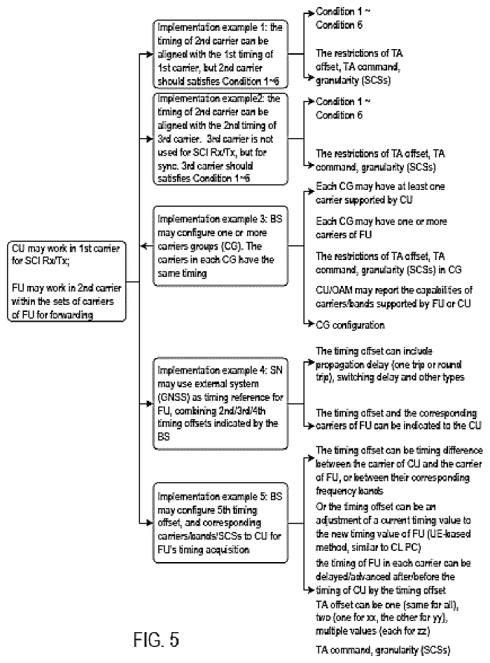

In the following part, the disclosure gives the methods for solving how to obtain FU (F-link) timing. FU timing may include FU DL timing and/or FU UL timing, such as DL receive timing, UL transmit timing, DL transmit timing, and/or UL receive timing. The first two can also be referred to as B-link timing, and the latter two can also be referred to as A-link timing. FIG. 5 illustrates a framework diagram of an example method for timing for smart nodes (SNs), in accordance with some embodiments of the present disclosure.

SN CU (or C-link) may work in a first carrier. The first carrier can at least obtain a first timing of SN CU (or C-link): a first DL (receive) timing and/or a first UL (transmit) timing. The first DL/UL timing for SN CU can be achieved using a UE mechanism. The first DL (receive) timing can be a time for receptions of the first carrier on the control link. The first UL (transmit) timing can be a time for transmissions of the first carrier on the control link. The definition of other types of timing can be similar to above.

The first DL timing: SN CU may detect DL signal (e.g., synchronization signal block (SSB)) transmitted by the base station in the first carrier to obtain the first DL timing by adopting a UE mechanism.

The first UL timing: SN CU may obtain the first UL timing according to UL signal (e.g. random access channel (RACH)) transmitted by CU in the first carrier by adopting a UE mechanism.

One or more of the following implementation examples can be implemented separately or in combination.

### Implementation Example 1: Align With a Timing of a C-link Carrier

SN CU (or C-link) may work in a first carrier for initial access and/or side control information reception/transmission, and may obtain a first timing in a first carrier, as discussed above.

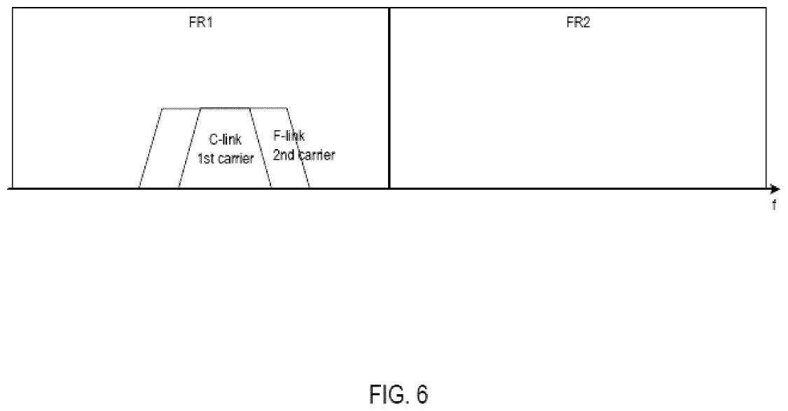

SN FU (or F/B-link) may work in a second carrier for forwarding. The second carrier can be a carrier within a set of carriers of SN FU (or F/B-link). An example is shown in FIG. 6. FIG. 6 illustrates a graph of two frequency ranges associated with respective links, in accordance with some embodiments of the present disclosure.

The first carrier (or the first frequency resource), the second carrier (or the second frequency resource) or the set of carriers (or frequency resources) of SN FU can be configured to SN by the station.

The timing of the second carrier of SN FU (or B-link) can be aligned with the first timing of SN CU (or C-link). At least one of the following example scenarios can occur:
The DL receive timing of SN FU can be aligned with the first DL timing (e.g. a time for receptions on the control link); and/or.
The UL transmit timing of SN FU can be aligned with the first UL timing (e.g. a time for transmissions on the control link); and/or
The DL transmit timing of SN FU can be delayed after the first DL timing by an internal delay, e.g., a time for transmissions on the access link incurs an SN-specific delay (internal delay) relative to a time for receptions on the control/backhaul link. SN-specific delay can be reported to the base station as an SN' capability via RRC signaling by SN, or informed to the base station via OAM, or declared by the vendors; and/or.
The UL receive timing of SN FU can be advanced before the first UL timing by an internal delay, e.g., the SN FU advances by the SN-specific delay a time for receptions on the access link relative to a time for transmissions on the control/backhaul link.

The timing of the second carrier of SN FU (or B-link) can be aligned with the first timing of SN CU (or C-link) when the second carrier satisfies at least one of the following conditions.
Condition 1: The second carrier can be any carrier within the set of carriers of SN FU.
Condition 2: The second carrier can be the same as the first carrier (e.g., the carrier of SN CU or C-link).
Condition 3: The second carrier and the first carrier can be in the same frequency band. Frequency band can be a band of frequency spectrum, such as operating band or frequency range.
Condition 4: The second carrier can be in a cell group (or in a carrier group, a set of carriers, or a frequency resource). For example, the second carrier and the first carrier can be in the same cell group. The cell group can be configured/indicated to SN (SN CU) by the BS via system information, radio resource control (RRC) signaling, medium access control control element (MAC CE), or downlink control information (DCI) signaling. The cell group can be defined as a set of cells or carriers that have same DL or UL timing. The cell group can be a timing advance group.
Condition 5: The second carrier can be in a frequency resources declared by SN. The frequency resources can also refer to a carrier, a set of carriers, a carrier/cell group or a frequency band(s). The timing of the carrier in the frequency resources can be aligned with the first timing. If the carriers in the same frequency resources, the carriers may have same DL or UL timing.
Condition 6: the second carrier can be in a frequency resources reported by SN to the BS. The frequency resources can also refer to a carrier, a set of carriers, a carrier/cell group or a frequency band(s). The timing of the carrier in the frequency resources can be aligned with the first timing. If the carriers in the same frequency resources, the carriers may have same DL or UL timing

A same timing advance offset value N_{TA,offset} may apply to the first carrier (e.g., the carrier of SN CU or C-link) and the second carrier (e.g., the carrier of SN FU or F/B-link). A received timing advance command where the uplink timing for UL transmissions can be the same for the first carrier (e.g., the carrier of SN CU or C-link) and the second carrier (e.g., the carrier of SN FU or F/B-link).

The base station can configure/indicate subcarrier spacings (SCSs) associated with the carriers (or active UL BWPs in the carriers) within the set of carriers of of SN FU (or F/B-link) to the SN (SN CU), e.g., the base station may configure/indicate SCS of the second carrier (or active UL BWP in the second carrier) to the SN. The timing advance command value can be relative/related to the largest or lowest SCS of the first carrier and the second carrier, or the timing advance command value can be relative/related to the SCS of the first carrier.

### Implementation Example 2: Align With a Timing of an Additional C-link Carrier

SN CU (or C-link) may work in a first carrier for initial access and/or side control information reception/transmission, and may obtain a first timing in a first carrier, as discussed above.

SN FU (or F/B-link) may work in a second carrier for forwarding. The second carrier is a carrier within the set of carriers of SN FU (or F/B-link).

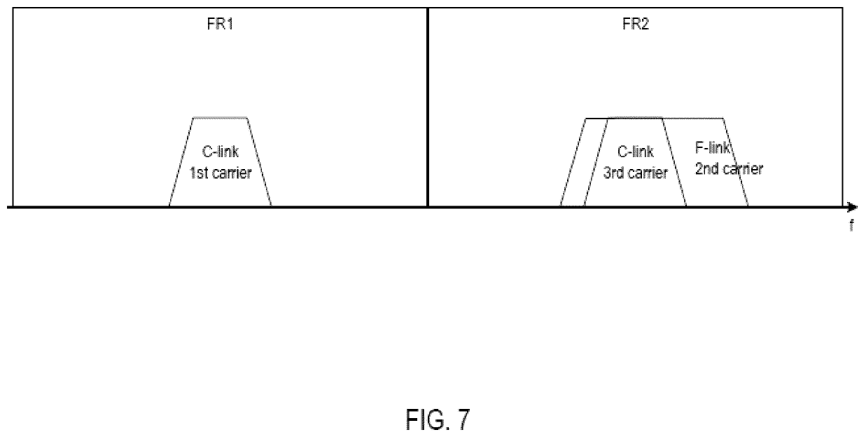

SN CU may obtain a third timing in a third carrier of SN CU (or C-link), e.g., using a UE mechanism (detect/transmit some signals (e.g., SSB, or RACH) from/to the BS) to obtain a third DL (receive) timing and/or a third UL (transmit) timing. Alternatively, the third carrier may not be used for side control information reception/transmission by SN CU. An example is shown in FIG. 7. FIG. 7 illustrates a graph of two frequency ranges associated with respective links, in accordance with some embodiments of the present disclosure.

The third DL timing: SN CU may detect DL signal (e.g., SSB) transmitted by the base station in the third carrier to obtain the third DL timing. Alternatively, a DL signal detected by the SN CU in the third carrier can be used for SN CU obtaining timing (e.g., radio frame timing and/or SFN), and may not be used for other purposes, e.g., measurement.

The third UL timing: SN CU may obtain the third UL timing according to UL signal (e.g. RACH) transmitted by CU in the third carrier. Alternatively, UL signals transmitted by SN CU in the third carrier can be used for SN CU obtaining UL timing, and may not be used for other purposes, e.g., measurement.

The timing of the second carrier of SN FU (or B-link) can be aligned with the third timing. At least one of the following example scenarios can occur:
The DL receive timing of SN FU can be aligned with the third DL timing; and/or
The UL transmit timing of SN FU can be aligned with the third UL timing; and/or.
The UL transmit timing of SN FU can be aligned with the first UL timing plus/minus one or multiple first timing offset. The first timing offset can be the difference between the first DL timing and the third DL timing. A new timing advance (TA) in the second carrier can be obtained or defined by the first UL timing (e.g., a TA obtained in first carrier) plus/minus one or multiple first timing offset. The SN (SN CU) can report the first timing offset and/or associated SCS to the base station; and/or.
The DL transmit timing of SN FU can be delayed after the third DL timing by an internal delay, e.g., a time for transmissions on the access link incurs an SN-specific delay (internal delay) relative to a time for receptions on the control/backhaul link; and/or.
The UL receive timing of SN FU can be advanced before the third UL timing by an internal delay, e.g., the SN FU advances by the SN-specific delay a time for receptions on the access link relative to a time for transmissions on the control/backhaul link.

The timing of the second carrier of SN FU (or B-link) can be aligned with the third timing when the third carrier satisfies at least one of the following conditions.
Condition 1: The third carrier can be any carrier or one carrier within the set of carriers of SN FU.
Condition 2: The third carrier can be the same as the second carrier (e.g., the carrier of SN CU or C-link).
Condition 3: The third carrier and the second carrier can be in the same frequency band. Frequency band can be a band of frequency spectrum, such as operating band or frequency range.
Condition 4: The third carrier can be in a cell group (or in a carrier group, a set of carriers, or a frequency resource). For example, the third carrier and the second carrier can be in the same cell group. The cell group can be configured/indicated to SN (SN CU) by the BS via system information, RRC signaling, MAC CE or DCI signaling. The cell group can be defined as a set of cells or carriers that have same DL or UL timing. The cell group can be a timing advance group.
Condition 5: the third carrier can be in a frequency resources declared by SN. The frequency resources can also refer to a carrier, a set of carriers, a carrier/cell group or a frequency band(s). If the carriers in the same frequency resources, the carriers may have same DL or UL timing. The third carrier and the second carrier can be in the same frequency resource.
Condition 6: The third carrier can be in a frequency resources reported by SN to the BS. The frequency resources can also refer to a carrier, a set of carriers, a carrier/cell group or a frequency band(s). If the carriers in the same frequency resources, the carriers may have same DL or UL timing. The third carrier and the second carrier can be in the same frequency resource.

A same timing advance offset value N_{TA,offset} may apply to the third carrier (e.g., the carrier of SN CU or C-link) and the second carrier (e.g., the carrier of SN FU or F/B-link). A received timing advance command where the uplink timing for UL transmissions can be the same for the third carrier (e.g., the carrier of SN CU or C-link) and the second carrier (e.g., the carrier of SN FU or F/B-link). The base station can configure/indicate SCSs associated with the carriers (or active UL BWPs in the carriers) within the set of carriers of of SN FU (or F/B-link) to SN (SN CU), e.g., the base station may configure/indicate SCS of the second carrier (or active UL BWP in the second carrier) to the SN. The timing advance command value can be relative/related to the largest or lowest SCS of the third carrier and the second carrier, or the timing advance command value can be relative/related to the SCS of the third carrier.

### Implementation Example 3: Configure Carrier Group With Same Timing

The base station can configure one or more carrier groups (or cell groups, a set of carriers/cells, frequency resources/bands). The configuration of carrier groups can be indicated to SN (SN CU) by the base station via system information, RRC signaling, MAC CE and/or DCI signaling.

Further, one or more of the following points can be performed.
Each carrier group at least may include one carrier that can be supported by SN CU, e.g., the first carrier.
Each carrier group can include one or more carriers within the set of carriers of SN FU, e.g., the second carrier.
SN CU may obtain the timings in each carrier supported by SN CU (e.g. using a UE mechanism).
The timing of the carrier within the set of carriers of SN FU (B-link) can be aligned with the timing of the carrier of SN CU, if above carriers in a same carrier group, including
   The DL receive timing of SN FU can be aligned with the first DL timing (e.g., a time for receptions on the control link); and/or
   the UL transmit timing of SN FU can be aligned with the first UL timing (e.g., a time for transmissions on the control link); and/or
   the DL transmit timing of SN FU is delayed after the first DL timing by an internal delay, e.g., a time for transmissions on the access link incurs an SN-specific delay (internal delay) relative to a time for receptions on the control/backhaul link; and/or
   the UL receive timing of SN FU is advanced before the first UL timing by an internal delay, e.g., the SN FU advances by the SN-specific delay a time for receptions on the access link relative to a time for transmissions on the control/backhaul link.
SN can be provided a value N_{TA,offset} of a timing advance offset for a carrier by the base station via system information, RRC signaling, MAC CE and/or DCI signaling. If SN is not provided for a carrier, SN determines a default value N_{TA,offset} of the timing advance offset for the carrier.
A same timing advance offset value N_{TA,offset} may apply to the carriers in the carrier group.
Upon reception of a timing advance command for a carrier group, the SN may adjust uplink timing for transmission on all the carriers in the carrier group based on a value N_{TA,offset} that the SN expects to be same for all the carriers in the carrier group and based on the received timing advance command where the uplink timing is the same for all the carriers in the carrier group.
The base station can configure/indicate SCSs associated with the carriers (or active UL BWPs in the carriers) within the carrier group to SN (SN CU). The timing advance command value can be relative/related to the largest or lowest SCS of the carriers (or active UL BWPs in the carriers), or the timing advance command value can be relative/related to the SCS of the carrier of SN CU in the carrier group.
SN (SN CU) or OAM can report the capabilities of frequency bands/carriers supported by SN FU and/or SN CU to the base station. The above capabilities may include at least one of the following: frequency band number, band combination, bandwidth (or aggregated bandwidth), the number of supported carriers, the frequency information of the frequency band or the carrier (index, central frequency, ARFCN, start/end frequency, and/or bandwidth).
The base station can configure carrier group(s) to SN (SN CU), the configuration of carrier group can include carrier group index (e.g., 0, 1, 2 . . . , or primary, secondary, . . . ), carrier list or carrier group list, the frequency information of the carrier or carrier group (index, central frequency, absolute radio frequency channel number (ARFCN), start/end frequency, and/or bandwidth).
If a carrier group includes the carrier of SN CU for side control information reception/transmission, the carrier group can be defined/configured as primary carrier group or carrier group with index 0.

### Implementation Example 4: External System as Timing Reference

The base station can configure/indicate a second timing offset(s) and/or a third timing offset(s) to SN (SN CU) via system information, RRC signaling, MAC CE and/or DCI signaling.

The timing offset unit (or adjusted granularity) can be N s, N ms, N us, N ns, N frames, N subframes, N slots, N symbols, etc., wherein N is a positive number. The timing offset unit (or adjusted granularity) can also be a multiple of a time constant. The value of the multiple can be related to the subcarrier spacing configuration u. The time constant can be a Tc. T_{c}=1/(Δffₘₐₓ( )) where Δfₘₐₓ=480·10³ Hz and N_{f}=4096. Correspondingly, the timing offset unit (or adjusted granularity) can be, such as, Tc, 64·Tc, 16·64·Tc, or 16·64·Tc/2^{u} (u is the subcarrier spacing configuration, u=0,1,2,3, . . . ,10), etc. The subcarrier spacing configuration u can be relative/related to a reference SCS, or respective SCSs of the first carrier and/or the carriers of SN FU (e.g., the second carrier), or the largest or lowest SCS of the first carrier and/or the carriers of SN FU (e.g., the second carrier), or the SCS of the first carrier. Above the information of SCS(s) can be informed to SN by the base station.

Further, one or more of the following points can be performed.
The second timing offset(s) can be the propagation delay between the base station and SN (one-trip or round-trip) and/or other types of time delay (e.g., other than propagation delay).
The third timing offset(s) can be the switching delay between DL and UL and/or other types of time delay (e.g., other than propagation/switching delay).
The second timing offset(s) and the third timing offset(s) can be combined into a single timing offset(s), such as a fourth timing offset(s). In such case, the fourth timing offset(s) includes propagation delay, switching delay and/or other types of time delay (e.g., other than propagation/switching delay).
The base station can configure/indicate the second timing offset(s) and/or the third timing offset(s) and the corresponding carrier(s) and/or the corresponding SCS(s) to SN via system information, RRC signaling, MAC CE and/or DCI signaling. In other words, the base station can configure/indicate the carriers and the corresponding second timing offset(s) and/or the corresponding third timing offset(s) and/or the corresponding SCS(s) to SN. The carriers may include the first carrier of SN-CU and/or the carriers within the set of carriers of SN-FU (e.g. the second carrier).
The SN can use a timing system (e.g. GNSS) as timing reference, and may combine the second timing offset(s), the third timing offset(s) and/or the fourth timing offset(s) to obtain the timing of the first carrier of SN CU and/or the carrier within the set of carriers of SN FU, e.g.,
   the DL receive timing of SN CU can be delayed/advanced after/before the timing reference by an or multiple second/third/fourth timing offset(s), and/or
   the UL transmit timing of SN CU can be delayed/advanced after/before the timing reference by an or multiple second/third/fourth timing offset(s), or the UL transmit timing of SN CU can be delayed/advanced after/before the DL receive timing of SN CU by an or multiple second/third/fourth timing offset(s), and/or
   the DL receive timing of SN FU can be delayed/advanced after/before the timing reference by an or multiple second/third/fourth timing offset(s), and/or
   the UL transmit timing of SN FU can be delayed/advanced after/before the timing reference by an or multiple second/third/fourth timing offset(s), or the UL transmit timing of SN FU can be delayed/advanced after/before the DL receive timing of SN FU by an or multiple second/third/fourth timing offset(s), and/or
   the DL transmit timing of SN FU can be delayed after the DL receive timing of SN FU by an internal delay, e.g., a time for transmissions on the access link incurs an SN-specific delay (internal delay) relative to a time for receptions on the control/backhaul link; and/or
   the UL receive timing of SN FU can be advanced before the UL transmit timing of SN FU by an internal delay, e.g., the SN FU advances by the SN-specific delay a time for receptions on the access link relative to a time for transmissions on the control/backhaul link.

### Implementation Example 5: Configure Timing Offset Between C-Carrier and F-Carrier

SN CU (or C-link) may work in a first carrier for initial access and/or side control information reception/transmission, and may obtain the first timing in the first carrier, as discussed above.

SN FU (or F/B-link) may work in a second carrier for forwarding. The second carrier can be a carrier within the set of carriers of SN FU (or F/B-link).

The base station can configure/indicate a fifth timing offset(s) to SN (SN CU) via system information, RRC signaling, MAC CE and/or DCI signaling.

The timing offset unit (or adjusted granularity) can be Ns, N ms, N us, N ns, N frames, N subframes, N slots, N symbols, etc., wherein N is a positive number. The timing offset unit (or adjusted granularity) can also be a multiple of a time constant. The value of the multiple can be related to the subcarrier spacing configuration u. The time constant can be a Tc. T_{c}=1/(Δffₘₐₓ( )) where Δfₘₐₓ=480·10³ Hz and N_{f}=4096. Correspondingly, the timing offset unit (or adjusted granularity) can be, such as, Tc, 64·Tc, 16·64·Tc, or 16·64·Tc/2^{u} (u is the subcarrier spacing configuration, u=0, 1, 2, 3, . . . , 10), etc. The subcarrier spacing configuration u can be relative/related to a reference SCS, or respective SCSs of the first carrier and/or the carriers of SN FU (e.g., the second carrier), or the largest or lowest SCS of the first carrier and/or the carriers of SN FU (e.g., the second carrier), or the SCS of the first carrier. Above the information of SCS(s) can be informed to SN by the base station.

Further, one or more of the following points can be performed.
The fifth timing offset(s) can be the timing difference(s) between the carrier of SN CU (e.g., the first carrier) and the carrier within the set of carriers of SN FU (e.g., the second carrier), or between the frequency band of the carrier of SN CU and the frequency band of the carrier of SN FU.
The base station can configure/indicate the fifth timing offset(s) and the corresponding information to SN via system information, RRC signaling, MAC CE and/or DCI signaling. The corresponding information may include at least one of: the corresponding carrier(s), the corresponding frequency band(s), or the SCS(s). For the corresponding carrier(s), the carriers within the set of carriers of SN FU (e.g. the second carrier). Each fifth timing offset can be associated with a carrier within the set of carriers of SN FU. For the corresponding frequency band(s), each fifth timing offset can be associated with a frequency band. For the SCS(s), each fifth timing offset can be associated with a SCS. The SCS can also be the SCS of the corresponding carrier of SN FU or the active BWP of the corresponding carrier. In other words, the base station can also configure/indicate the carriers/frequency bands and the corresponding fifth timing offset(s) and/or the corresponding SCS(s) to SN. The carriers may include the first carrier of SN-CU and/or the carriers within the set of carriers of SN-FU (e.g. the second carrier).
The fifth timing offset(s) can be further divided into a fifth DL timing offset(s) and a fifth DL timing offset(s). The fifth DL timing offset(s) is used for FU DL (e.g., receive) timing acquisition and the fifth UL (e.g., transmit) timing offset(s) can be used for FU UL timing acquisition. The BS may indicate the fifth DL timing offset(s) and the fifth UL timing offset(s) to SN (SN CU).
For timing advance offset value N_{TA,offset}. A same common timing advance offset value N_{TA,offset} may apply to the first carrier (e.g., the carrier of SN CU or C-link) and/or (all) the carriers within the set of carriers of SN FU (or F/B-link). N_{TA,offset} can be configured/indicated to SN by the BS or can be determined a default value by SN. Alternatively, the base station can configured/indicated more than one timing advance offset value to SN (SN CU) (e.g., two values or multiple values). For example (two values), the two values can be one for frequency band/range 1 and the other for frequency band/range 2. For another example (two values), the two values can be one for the first carrier (e.g., the carrier of SN CU or C-link), the other for the set of carriers of SN FU (or F/B-link). For instance (multiple values), except for the first carrier, each value of the multiple values may correspond to a carrier within the set of carriers of SN FU, or each value of the multiple values may correspond to a frequency band/range that the carriers within the set of carriers of SN FU belong to. That means/indicates that the timing advance offset can be a dedicated timing advance offset, e.g., FU-dedicated, access/forwarding-link dedicated, carrier-dedicated, frequency band-dedicated, etc.
A received timing advance command can be the same for the first carrier (e.g., the carrier of SN CU or C-link) and the carriers of SN FU (B-link), e.g., above carriers can share a common timing advance command value. The base station can also indicate a dedicated timing advance command value for the carrier within the set of carriers of SN FU. The dedicated timing advance command value can be FU-dedicated, access/forwarding-link dedicated, carrier-dedicated, frequency band-dedicated, etc.
The timing advance command value can be relative/related to the largest or lowest SCS of the first carrier and the carriers of SN FU (B-link) (e.g., the second carrier), or the timing advance command value can be relative/related to the SCS of the first carrier.
   The timing of SN FU (B-link) in each carrier can be obtained based on the timing of SN CU (C-link), and combined with the fifth timing offset(s) and/or timing advance offset(s).
The second timing of the second forwarding link can be obtained through at least one of the following parameters: a common timing advance command value, a dedicated timing advance command value, a common timing advance offset, a dedicated timing advance offset, or the timing offset.
For example, SN CU can start T_{TA}=(N_{TA}+N_{TA,offset}+Nₒₜₕₑᵣₛ)T_{c} for UL transmission before the start of the corresponding downlink frame at the SN CU, where N_{TA} is obtained from timing advance command, N_{TA,offset} is a timing advance offset value, Nₒₜₕₑᵣₛ represents other timing impact, and it is optional. Then, SN FU can start T_{TA}=(N_{TA}+N_{TA,offset}1+Nₒₜₕₑᵣₛ+N_{fifth offset})T_{c} for UL transmission, where N_{TA,offset1} can be the same or different as N_{TA,offset}, depending the timing advance offset is configured as common or dedicated. N_{fifth offset} is the fifth timing offset.
For another example,
   the DL receive timing of SN FU can be delayed/advanced after/before the first DL timing (e.g. a time for receptions on the control link) by an or multiple fifth timing offset(s), and/or
   the UL transmit timing of SN FU can be delayed/advanced after/before the first UL timing (e.g. a time for transmissions on the control link) by an or multiple fifth timing offset(s), or the UL transmit timing of SN FU can be delayed/advanced after/before the DL receive timing of SN FU by a (common) timing advance command value, a (common or dedicated) timing advance offset, and/or other timing parameters.
   the DL transmit timing of SN FU can be delayed after the DL receive timing of SN FU by an internal delay, e.g., a time for transmissions on the access link incurs an SN-specific delay (internal delay) relative to a time for receptions on the backhaul link; and/or
   the UL receive timing of SN FU can be advanced before the UL transmit timing of SN FU by an internal delay, e.g., the SN FU advances by the SN-specific delay a time for receptions on the access link relative to a time for transmissions on the backhaul link.
The fifth timing offset(s) can be the timing difference(s) between current (old) timing of FU and new timing of FU. In other words, the fifth timing offset(s) can be indicated for an adjustment of a current timing value to the new timing value. Adjustment of an fifth timing offset value by a positive or a negative amount may indicate advancing or delaying the DL/UL Rx/Tx timing for the FU by a corresponding amount, respectively.

It should be understood that one or more features from the above implementation examples are not exclusive to the specific implementation examples, but can be combined in any manner (e.g., in any priority and/or order, concurrently or otherwise).

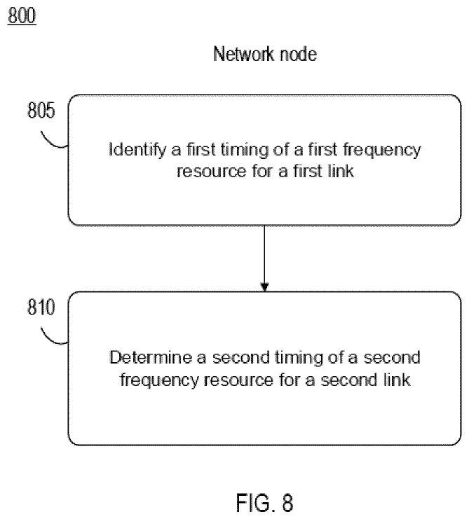

FIG. 8 illustrates a flow diagram of a method 800 for timing for smart nodes (SNs). The method 800 may be implemented using any one or more of the components and devices detailed herein in conjunction with FIGS. 1-2. In overview, the method 800 may be performed by a network node, in some embodiments. Additional, fewer, or different operations may be performed in the method 800 depending on the embodiment. At least one aspect of the operations is directed to a system, method, apparatus, or a computer-readable medium.

A network node (e.g., a smart node (SN)) may identify a first timing of a first frequency resource for a first link. The network node may determine a second timing of a second frequency resource for a second link. The first link may comprise at least one of: a first control link from a wireless communication node (e.g., a BS) to the network node; or a second control link from the network node to the wireless communication node. The second link may comprise at least one of: a first forwarding link from the wireless communication node to the network node; a second forwarding link from the network node to the wireless communication node; a third forwarding link from the network node to a wireless communication device; or a fourth forwarding link from the wireless communication device to the network node.

In some embodiments, the first frequency resource and/or the second frequency resource refer to at least one of: a carrier, a channel, a passband, a resource block group, a resource block set, a subband, a guard band, a bandwidth part, a frequency band, an operation band, a frequency range, a cell, a serving cell, or a band of frequency spectrum.

In some arrangements, the second timing can be related to the first timing, which refers to at least one of: the second timing of the first forwarding link is aligned with the first timing of the first control link; the second timing of the second forwarding link is aligned with the first timing of the second control link; the second timing of the third forwarding link is delayed after the first timing of the first control link or after the second timing of the first forwarding link by an first time delay; the second timing of the fourth forwarding link is advanced before the first timing of the second control link or before the second timing of the second forwarding link by a an second time delay; or the second timing of the second forwarding link is delayed/advanced after/before the third timing of a third frequency resource of the second control link by an third time delay, wherein the third time delay is related to a difference between the first timing of the first control link and the third timing of a third frequency resource of the first control link.

In some embodiments, the second timing can be related to/aligned with (“aligned with” can be one embodiment of “related to”) the first timing (e.g., the first timing in implementation example 1), when at least one of the following conditions is met: (a) the second frequency resource is any frequency resource within a set of frequency resource for the second link; (b) the second frequency resource is identical to the first frequency resource (e.g., the first carrier in implementation example 1); (c) the first frequency resource and the second frequency resource are in a same frequency band; (d) the second frequency resource is in a frequency resource group or a cell group; (e) the second frequency resource is in a frequency resource declared by the network node; or (f) the second frequency resource is in a frequency resource reported by the network node to the wireless communication node.

In some embodiments, the first carrier (e.g., the first carrier in implementation example 1 or the third carrier in implementation example 2) can be or can not be configured for side control information reception or transmission.

In some embodiments, the second timing can be related to/aligned with (“aligned with” can be one embodiment of “related to”) the first timing (e.g., the third timing in implementation example 2), when at least one of the following conditions is met: (a) the first frequency resource (e.g., the third carrier in implementation example 2) is one frequency resource or any carrier within a set of frequency resource for the second link; (b) the first frequency resource is identical to the second frequency resource; (c) the first frequency resource and the second frequency resource are in a same frequency band; (d) the first frequency resource is in a frequency resource group or a cell group; (e) the first frequency resource is in a frequency resource declared by the network node; or (f) the first frequency resource is in a frequency resource reported by the network node to the wireless communication node.

In some embodiments, the network node may receive a first message indicating at least one or more frequency resource groups, each of which comprising one or more frequency resource. The first frequency resource and the second frequency resource can be in a same one of the one or more frequency resource groups. The one or more frequency resource in a same frequency resource group may share a common timing value. The one or more frequency resource in the same frequency resource group can be supported by the first link. The one or more frequency resource in the same frequency resource group can be within a set of frequency resource for the second link. A timing of one or more frequency resource in the same frequency resource group for the second link can be related to/aligned with a timing of one or more frequency resources in the same frequency resource group for the first link. The common timing value may include a common timing advance offset. The common timing advance offset can be indicated by a second message receiving by the network node from the wireless communication node, or can be determined a default value by the network node.

In some embodiments, the common timing value may include a common timing advance command value in a timing advance command. The timing advance command can be indicated by a third message receiving by the network node from the wireless communication node. The network node may receive a fourth message indicating a reference SCS, or respective SCSs associated with the one or more frequency resources from the wireless communication node. The common timing advance command value can be relative to/related to the reference SCS, or a largest or lowest one of the SCSs, or relative to one of the SCSs associated with a corresponding one of the one or more frequency resources for the first link, or the SCS of the first frequency resource, or the SCS of the second frequency resource. The network node may adjust downlink timing or uplink timing on all the frequency resources in the same frequency resource group based on the common timing value.

In some embodiments, the network node may receive a first message indicating a timing offset from the wireless communication node.

In some arrangements, a unit or a granularity of the timing offset refers to at least one of: N seconds, N milliseconds, N microseconds, N nanoseconds, N frames, N subframes, N slots, N symbols, N·Tc, or M·Tc, wherein N is a positive number, Tc is a time constant, and M is related to a subcarrier spacing configuration. The timing offset may include a first timing offset and/or a second timing offset. The first timing offset may include a propagation delay present between the network node and the wireless communication node, and/or the second timing offset may include a switching delay present between a UL transmission/reception and a DL transmission/reception. The first message may further indicate a third timing offset. The third timing offset can be a combination of the first timing offset and the second timing offset. The network node may receive a second message indicating one or more frequency resources for the second link that correspond to the first timing offset and/or the second timing offset from the wireless communication node.

In some arrangements, the network node may determine the second timing through combining a timing reference and/or the first timing offset and/or the second timing offset, including at least one of the following: the first timing of the first control link is delayed/advanced after/before the timing reference by one or multiple of the first timing offset and/or the second timing offset; the first timing of the second control link is delayed/advanced after/before the timing reference by one or multiple of the first timing offset and/or the second timing offset, or the first timing of the second control link is delayed/advanced after/before the first timing of the first control link by one or multiple of the first timing offset and/or the second timing offset; the second timing of the first forwarding link is delayed/advanced after/before the timing reference by one or multiple of the first timing offset and/or the second timing offset; the second timing of the second forwarding link is delayed/advanced after/before the timing reference by one or multiple of the first timing offset and/or the second timing offset, or the second timing of the second forwarding link is delayed/advanced after/before the second timing of the first forwarding link by one or multiple of the first timing offset and/or the second timing offset; the second timing of the third forwarding link is delayer after the second timing of the first forwarding link by one or multiple of the first timing offset and/or the second timing offset; or the second timing of the fourth forwarding link is advanced before the second timing of the second forwarding link by one or multiple of the first timing offset and/or the second timing offset.

In some embodiments, the timing offset can be a timing difference between the first frequency resource and the second frequency resource, or a timing difference between a current one of the second timing and a new one of the second timing. The first message may further indicate information corresponding to the timing offset. The information may comprise at least one of: the second frequency resource, a frequency band corresponding to the second frequency resource, or an SCS corresponding to the second frequency resource. The timing offset may include a UL timing offset and/or a DL timing offset. The network node may receive a third message indicating a plurality of timing advance offsets from the wireless communication node.

In some embodiments, a first one of the plurality of timing advance offsets can be configured for the first frequency resource. A second one of the plurality of timing advance offsets can be configured for the second frequency resource. The first frequency resource and the second frequency resource may share a common timing advance offset, which can be indicated by a fifth message receiving by the network node from the wireless communication node, or can be determined a default value by the network node.

In some embodiments, the first frequency resource and the second frequency resource may share a common timing advance command value in a timing advance command, which can be indicated by a second message receiving by the network node from the wireless communication node. The common timing advance offset command value can be relative to a reference SCS, a largest or lowest one of a plurality of SCSs associated with the first link and the second link, respectively, or relative to one of the SCSs associated with the first link, or the SCS of the first frequency resource, or the SCS of the second frequency resource.

In some arrangements, the network node may determine the second timing including at least one of the following: the second timing of the first forwarding link is delayed/advanced after/before the first timing of the first control link by one or multiple of the timing offset; the second timing of the second forwarding link is delayed/advanced after/before the first timing of the second control link by one or multiple of the timing offset, or the second timing of the second forwarding link is delayed/advanced after/before the second timing of the first forwarding link by one or multiple of the timing offset; the second timing of the third forwarding link is delayer after the second timing of the first forwarding link by one or multiple of the timing offset; the second timing of the fourth forwarding link is advanced before the second timing of the second forwarding link by one or multiple of the timing offset; or the second timing of the second forwarding link is obtained through at least one of the following parameters: a common timing advance command value, a dedicated timing advance command value, a common timing advance offset, a dedicated timing advance offset, the timing offset.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

What is claimed is:

1. A wireless communication method, comprising:
identifying, by a network node, a first timing of a first frequency resource for a first link; and
determining, by the network node, a second timing of a second frequency resource for a second link;
wherein the first link comprises at least one of:
a first control link from a wireless communication node to the network node; or
a second control link from the network node to the wireless communication node;
wherein the second link comprises at least one of:
a first forwarding link from the wireless communication node to the network node;
a second forwarding link from the network node to the wireless communication node;
a third forwarding link from the network node to the wireless communication device; or
a fourth forwarding link from the wireless communication device to the network node.

2. The wireless communication method of claim 1, wherein the first frequency resource and/or the second frequency resource refer to at least one of: a carrier, a channel, a passband, a resource block group, a resource block set, a subband, a guard band, a bandwidth part, a frequency band, an operation band, a frequency range, a cell, a serving cell, or a band of frequency spectrum.

3. The wireless communication method of claim 1, wherein the second timing is related to the first timing, which refers to at least one of:
the second timing of the first forwarding link is aligned with the first timing of the first control link;
the second timing of the second forwarding link is aligned with the first timing of the second control link;
the second timing of the third forwarding link is delayed after the first timing of the first control link or after the second timing of the first forwarding link by a first time delay;
the second timing of the fourth forwarding link is advanced before the first timing of the second control link or before the second timing of the second forwarding link by a second time delay; or
the second timing of the second forwarding link is delayed after or advanced before the third timing of a third frequency resource of the second control link by a third time delay, wherein the third time delay is related to a difference between the first timing of the first control link and the third timing of a third frequency resource of the first control link.

4. The wireless communication method of claim 1, wherein the second timing is related to the first timing, when at least one of following conditions is met:
(a) the second frequency resource is any frequency resource within a set of frequency resources for the second link;
(b) the second frequency resource is identical to the first frequency resource;
(c) the first frequency resource and the second frequency resource are in a same frequency band;
(d) the second frequency resource is in a frequency resource group or a cell group;
(e) the second frequency resource is in a frequency resource declared by the network node; or
(f) the second frequency resource is in a frequency resource reported by the network node to the wireless communication node.

5. The wireless communication method of claim 1, wherein the first frequency resource is or is not configured for side control information reception or transmission.

6. The wireless communication method of claim 1, wherein the second timing is related to the first timing, when at least one of following conditions is met:
(a) the first frequency resource is one frequency resource or any frequency resource within a set of frequency resources for the second link;
(b) the first frequency resource is identical to the second frequency resource;
(c) the first frequency resource and the second frequency resource are in a same frequency band;
(d) the first frequency resource is in a frequency resource group or a cell group;
(e) the first frequency resource is in a frequency resource declared by the network node; or
(f) the first frequency resource is in a frequency resource reported by the network node to the wireless communication node.

7. The wireless communication method of claim 1, further comprising:
receiving, by the network node from the wireless communication node, a first message indicating one or more frequency resource groups, each of which comprises one or more frequency resources;
wherein the first frequency resource and the second frequency resource are in a same one of the one or more frequency resource groups.

8. The wireless communication method of claim 7, wherein the one or more frequency resources in a same frequency resource group share a common timing value.

9. The wireless communication method of claim 7, wherein the one or more frequency resources in a same frequency resource group are supported by the first link.

10. The wireless communication method of claim 7, wherein the one or more frequency resources in a same frequency resource group are within a set of frequency resources for the second link.

11. The wireless communication method of claim 7, wherein a timing of one or more frequency resources in a same frequency resource group for the second link is related to a timing of one or more frequency resources in a same frequency resource group for the first link.

12. The wireless communication method of claim 8, wherein the common timing value includes a common timing advance offset, which is indicated by a second message received by the network node from the wireless communication node, or is determined via a default value by the network node.

13. The wireless communication method of claim 8, wherein the common timing value includes a common timing advance command value in a timing advance command, which is indicated by a third message received by the network node from the wireless communication node.

14. The wireless communication method of claim 13, further comprising:
receiving, by the network node from the wireless communication node, a fourth message indicating a reference SCS, or respective SCSs associated with the one or more frequency resources;
wherein the common timing advance command value is relative to the reference SCS, or a largest or lowest one of the SCSs, or relative to one of the SCSs associated with a corresponding one of the one or more frequency resources for the first link, or the SCS of the first frequency resource, or the SCS of the second frequency resource.

15. The wireless communication method of claim 8, further comprising:
adjusting, by the network node, downlink timing or uplink timing on all frequency resources in the same frequency resource group based on the common timing value.

16. The wireless communication method of claim 1, further comprising:
receiving, by the network node from the wireless communication node, a first message indicating a timing offset.

17. The wireless communication method of claim 16, wherein a unit or a granularity of the timing offset refers to at least one of: N seconds, N milliseconds, N microseconds, N nanoseconds, N frames, N subframes, N slots, N symbols, N·Tc, or M·Tc, wherein Nis a positive number, Tc is a time constant, and M is related to a subcarrier spacing configuration.

18. The wireless communication method of claim 16, wherein the timing offset includes a first timing offset and/or a second timing offset.

19. The wireless communication method of claim 18, wherein the first timing offset includes a propagation delay present between the network node and the wireless communication node, and/or the second timing offset includes a switching delay present between a UL transmission or reception and a DL transmission or reception.

20. A network node, comprising:
at least one processor configured to:
identify a first timing of a first frequency resource for a first link; and
determine a second timing of a second frequency resource for a second link;
wherein the first link comprises at least one of:
a first control link from a wireless communication node to the network node; or
a second control link from the network node to the wireless communication node;
wherein the second link comprises at least one of:
a first forwarding link from the wireless communication node to the network node;
a second forwarding link from the network node to the wireless communication node;
a third forwarding link from the network node to the wireless communication device; or
a fourth forwarding link from the wireless communication device to the network node.
